(19) United States
(12) Patent Application Publication
(10) Pub. No.: US 2025/0368063 A1
(43) Pub. Date: Dec. 4, 2025

(54) ELECTRIC RAIL VEHICLE CHARGING SYSTEM

(71) Applicant: First Greater Western Limited, Swindon (GB)

(72) Inventors: Stuart Charles Bower, Rugby, Warwickshire (GB); Richard Baker, Pershore, Worcestershire (GB); Ian Campbell-Kelly, Stone, Staffordshire (GB); Peter Mason, Stone, Staffordshire (GB)

(21) Appl. No.: 18/878,021

(22) PCT Filed: Jun. 16, 2023
(86) PCT No.: PCT/GB2023/051589

§ 371 Date: Dec. 21, 2024

(30) Foreign Application Priority Data
Jun. 22, 2022 (GB) 2209176.3
Jul. 1, 2022 (GB) 2209686.1
Aug. 30, 2022 (GB) 2212545.4
Nov. 4, 2022 (GB) 2216499.0

(51) Int. Cl. B60L 53/14; B60L 5/38; B60L 53/66; B60L 53/68; B61C 3/00

(52) U.S. Cl. CPC B60L 53/14; B60L 5/38; B60L 53/66; B60L 53/68; B61C 3/00; B60L 2200/26

(57) ABSTRACT

An onboard charging system configured for installation on a rail vehicle is provided, comprising: one or more current collection contacts; a battery, electrically connectable to the one or more current collection contacts; and an onboard charging controller having a wireless communications interface. The onboard charging controller is configured to: establish a secure wireless communication connection with a first trackside charging controller; and responsive to determining that the one or more current collection contacts have been brought into electrical contact with corresponding trackside charging contacts: instruct the first trackside charging controller, via the secure wireless communication connection, to provide a first current via the one or more trackside charging contacts.

### FIELD OF INVENTION

The present invention relates to systems and methods for charging electric vehicles, and in particular battery electric rail vehicles.

### BACKGROUND

Ongoing electrification of rail vehicles is a key part of de-carbonising the rail transport sector. However, many electric rail vehicles require a permanent connection to a high voltage power supply infrastructure, for example catenary or electrified “third rails”. Such infrastructure is highly expensive, and its installation is not possible in all locations.

One known solution is to provide battery-powered rail vehicles. Such vehicles do not require additional infrastructure along the whole length of a route. Instead, on-board batteries are charged at predetermined locations along the route to ensure that the vehicle has sufficient stored energy to traverse the route.

Patent application publication WO 2019229479 A1 describes a charging system for a battery electric rail vehicle including a charging rail dimensioned to be fully coverable by a train carriage; a power supply for charging an electric train battery, the power supply being configured to selectively supply a charging current to the charging rail; and, a sensor apparatus configured to detect the position and/or movement of a train carriage over the charging rail; in which the sensor is connected to the power supply such that the charging current is only supplied to the charging rail when the train carriage at least partially covers the charging rail.

It is desired to further improve the effectiveness and speed with which battery-electric rail vehicles can be charged at a charging location.

### SUMMARY OF INVENTION

In a first aspect of the present invention, there is provided an onboard charging system configured for installation on a rail vehicle, the onboard charging system comprising: one or more current collection contacts (for example current collection shoes); a battery (preferably suitable for powering a traction motor) electrically connectable to the one or more current collection contacts; and an onboard charging controller (a hardware controller, for example part of a traction control unit or a battery management unit, or a separate computing device or devices) having, or being communicatively coupled to, a wireless communications interface. The onboard charging controller is configured to: establish a secure wireless communication connection with a first trackside (e.g. stationary) charging controller (also a hardware controller, for instance a computing device); and responsive to determining that the one or more current collection contacts have been brought into electrical contact with corresponding trackside charging contacts: instruct the first trackside charging controller, via the secure wireless communication connection, to provide a first current via the one or more trackside charging contacts (either a charging current to charge the battery, or a lower current for the purpose of testing the quality/resistance of the electrical connection between the respective trackside charging contacts and current collection contacts).

Advantageously, the present invention provides a particularly effective means for automating charging of battery electric rail vehicles. By governing the charging process by an onboard controller, the charging can be made responsive to the particular requirements of individual battery-equipped rail vehicles (for example tailored to the state of charge of the battery at that point in time). By providing a secure wireless connection between the onboard controller and a trackside controller, the onboard controller can efficiently (for example, before the rail vehicle has reached a standstill) provide the trackside controller with information needed to correctly configure the trackside charging contacts. Moreover, so long as the rail vehicle is caused to stop such that the current collection contacts are in electrical connection with trackside charging contacts, the invention allows tailored, vehicle specific charging to proceed automatically, without any need for a human operator to make any electrical connections, instigate charging or control the charging process. Thus, the charging process is ‘invisible’ to a driver, who can operate the rail vehicle in the same manner as any other rail vehicle, and does not need to make any additional inputs for the purpose of charging the battery. Further, this arrangement also allows for easy retrofitting of the onboard charging system to existing rail vehicles, as the onboard controller and trackside controller can operate independently of, and require no integration with, many of the electric and electronic systems already present on existing rail vehicles.

In the preferred embodiment, prior to establishing the secure wireless communication connection, the onboard controller is configured to select the first trackside controller to communicate with from a plurality of trackside controllers (e.g. choose which of the trackside controllers provided at a charging location corresponds to trackside charging contacts positioned below the rail vehicle when the vehicle has stopped at the correct location) based on receiving, via a first signal receiver (e.g. communicatively coupled to the onboard controller, such as an RFID-radio frequency identification-reader/interrogator), a signal from a trackside signal transmitter (e.g. an RFID beacon). For example, the signal may indicate the expected direction of travel of rail vehicles along a particular route. Beneficially, this provides a means for the onboard controller to determine the orientation of the rail vehicle relative to the trackside charging contacts without needing either human input or interrogation of other systems on the rail vehicle.

Preferably the onboard charging system further comprises a first signal receiver and a second signal receiver. Prior to establishing the secure wireless communication connection, the onboard controller is configured to select the first trackside controller to communicate with from a plurality of trackside controllers based on receiving a first signal from a trackside signal transmitter at the first signal receiver prior to receiving a second signal from the trackside signal transmitter at the second signal receiver. This also provides an effective means for determining rail vehicle orientation without the need for a specific input or interrogation of other systems on the rail vehicle.

Optionally the onboard controller is configured to determine that the one or more current collection contacts have been brought into electrical contact with the trackside charging contacts based on the first signal receiver receiving a third signal from a second trackside signal transmitter (e.g., RFID tag/beacon). In this arrangement the onboard controller is configured to instruct the first trackside controller to stop providing current if the first signal receiver stops receiving the third signal. This advantageously provides an interlock to enhance safety during charging.

Optionally, responsive to the first current being provided, the onboard controller is configured to: monitor a first voltage at the one or more current collection contacts; receive information from the first trackside controller, via the secure communication connection, indicative of a second voltage at the one or more trackside charging contacts; compare a difference between the first voltage and the second voltage to a threshold value (or a predetermined range); and in response to determining that the difference is below the threshold value (or outside the range): connect the one or more current collection contacts to the battery; and instruct the first trackside controller to provide a second current (e.g. the full charging current), higher than the first current. This provides an effective means for automatically checking contact quality/resistance before starting charging at the full current.

Optionally the onboard controller is configured to determine that one or more current collection contacts have been brought into electrical contact with the corresponding trackside charging contacts based on receiving a signal from a proximity sensor indicative of the rail vehicle being proximate to the trackside charging contacts. Thus, the proximity sensor also provides an interlock to enhance safety during charging.

Optionally the onboard charging system further comprises an earthing connection connected to a rail vehicle chassis, wherein the onboard controller is configured to: responsive to determining that the one or more current collection contacts have been brought into electrical contact with the corresponding trackside charging contacts, and prior to connecting the battery to the one or more current collection contacts, disconnect the battery and the one or more current collection contacts from the earthing connection. This allows the battery to be earthed through the current collection contacts and the trackside charging contacts, reducing the possibility of a current return path through the rail vehicle chassis, again enhancing safety during charging.

Optionally, the onboard controller is configured to collect data including a level of charge of the battery and transmit the data to an external computing device for remote condition monitoring.

In another aspect of the present invention, there is provided a rail vehicle comprising the onboard charging system above.

In a further aspect of the invention, there is provided a trackside charging system configured for charging a battery electric vehicle, the trackside charging system comprising: a first trackside charging contact (for example a rail and/or ramp-shaped contact) electrically connectable to an electrical power supply (for example a storage battery, or a connection to another source of electrical power); and a trackside controller having, or being communicatively coupled to, a wireless communications interface. The trackside charging controller is configured to: establish a secure wireless communication connection with a first onboard charging controller; receive, via the wireless communication connection, an instruction to provide a first current (e.g., charging current or preliminary current for contact resistance checking); responsive to receiving the instruction, connect the first trackside charging contact to the electrical power source, thereby providing the first current.

Optionally the trackside charging system comprises a plurality of trackside charging contacts electrically connectable to the electrical power supply; wherein the trackside controller is configured to select the first trackside contact for connection to the electrical power supply based on a unique identifier (e.g., IP address) received from the first onboard controller via the secure wireless communication session. This provides an effective means for allowing direction-agnostic charging of the battery electric vehicle-using the unique identifier, the trackside controller can automatically connect the correct configuration of trackside charging contacts to match the positions of the current collection contacts as determined by the rail vehicle's orientation.

Preferably the trackside controller is configured to disconnect the first trackside charging contact from the electrical power supply responsive to the secure wireless communication connection being lost, providing a further safety interlock.

Optionally the trackside charging system comprises an earthing line connected to electrical ground, wherein the controller is configured to: responsive to receiving the instruction and prior to connecting the first charging contact to the electrical power supply, disconnect the first charging contact from the earthing line.

Optionally the trackside charging system further comprises one or more proximity sensors (for example mounted to a platform or other structure proximate to the trackside charging contacts) configured to detect the presence of a rail vehicle at a position corresponding to the first charging contact. In this case, the trackside controller is configured to: connect the first charging contact to the electrical power source responsive to receiving the instruction and receiving a signal from the proximity sensor indicative of a rail vehicle being present at a position corresponding to the first charging contact; and disconnect first charging contact from the electrical power source responsive to no longer receiving the signal from the proximity sensor.

Optionally the trackside controller is further configured to: monitor a first voltage at the first trackside contact while the first current is being provided; communicate the monitored first voltage to the onboard controller via the secure wireless communication connection; responsive to communicating the monitored first voltage, receive an instruction to provide a second current to the first trackside contact, the second current higher than the first current, and instruct the power supply to provide the second current.

Optionally the trackside controller is configured to collect data including a level of charge of the power supply and transmit the data to an external computing device for remote condition monitoring.

In a further aspect, there is provided a rail vehicle charging system comprising the onboard charging system and the trackside charging system above.

In a further aspect, there is provided a method (implemented on one or more computing or other hardware devices, for example on the onboard and trackside controllers above) for charging a battery on a rail vehicle. The method comprises: establishing a secure wireless communication connection between an onboard controller located on the rail vehicle and a first trackside charging controller; and determining that a first current collection contact located on the rail vehicle has been brought into electrical contact with a first corresponding trackside charging contact; in response to the determining: instructing the first trackside charging controller, by the onboard controller via the secure wireless communication connection, to provide a first current via the first trackside charging contacts; and in response to the instructing: connecting, by the trackside controller, the first trackside charging contact to an electrical power supply, thereby providing the first current.

Optionally the method includes, prior to establishing the secure wireless communication connection: selecting, by the onboard controller, the first trackside controller to communicate with from a plurality of trackside controllers based on receiving, a signal from a trackside signal transmitter.

Optionally the method includes, prior to establishing the secure wireless communication connection: selecting, by the onboard controller, the first trackside controller to communicate with from a plurality of trackside controllers based on receiving a first signal from a trackside signal transmitter at a first signal receiver prior to receiving a second signal from the trackside signal transmitter at a second signal receiver.

Optionally, determining that the first current collection contact has been brought into electrical contact with the first trackside charging contact comprises receiving a third signal from a second trackside signal transmitter. In this case the method preferably also includes instructing, by the onboard controller, the first trackside controller to stop providing the first current if the first signal receiver stops receiving the third signal.

Optionally the method includes: monitoring a first voltage at the one or more current collection contacts; monitoring a second voltage at the one or more trackside charging contacts; comparing a difference between the first voltage and the second voltage to a threshold value; and in response to determining that the difference is below the threshold value: connecting the battery to the one or more current collection contacts; instructing the first trackside controller to provide a second current, higher than the first current.

Optionally, determining that the first current collection contact has been brought into electrical contact with the first trackside charging contact comprises receiving a signal from a proximity sensor indicative of the rail vehicle being proximate to the trackside charging contacts.

Optionally the method includes: responsive to determining that the first current collection contact has been brought into electrical contact with the first trackside charging contact, and prior to connecting the battery to the first current collection contact, disconnecting the battery and the first current collection contact from the earthing connection.

Optionally the method includes: receiving, by the first trackside controller and via the secure wireless communication connection, a unique identifier from the onboard controller; selecting, by the first trackside controller the first trackside charging contact from a plurality of trackside charging contacts for connection to the electrical power supply based on the unique identifier.

Optionally the method includes disconnecting the first charging contact from the electrical power supply responsive to the secure wireless communication connection being lost.

Optionally the method includes: responsive to receiving the instruction and prior to connecting the first charging contact to the electrical power supply, disconnecting the first charging contact from an earthing line.

Optionally the method includes, sending data to an external computing device for remote monitoring, the data comprising one or more of: a state (or level) of charge of the battery; a state (or level) of charge of the power supply.

In a further aspect, the invention provides a computer-readable medium (for example a non-transitory computer readable medium) comprising instructions that, when executed on one or more processors (for example by the onboard and trackside controllers above) cause the one or more processors to perform the method above.

### BRIEF DESCRIPTION OF THE DRAWINGS

Embodiments of the present invention will now be described, by way of example only, with reference to the following figures. Like reference numerals refer to like elements throughout.

FIG. 1A shows a schematic side view of a portion of a battery electric rail vehicle in accordance with the present invention.

FIG. 1B shows a schematic top view of a portion of the battery electric rail vehicle of FIG. 1A.

FIG. 2A shows a schematic top view of a trackside charging system in accordance with the present invention.

FIG. 2B shows a schematic side view of the trackside charging contact of the trackside charging system of FIG. 2A.

FIG. 2C shows a schematic top view of further alternative trackside charging infrastructure.

FIG. 2D shows a schematic top view of an arrangement including the trackside charging infrastructure of FIG. 2C and the trackside charging infrastructure of FIG. 2A.

FIG. 3 shows a schematic illustrating the interface between the onboard charging system and the trackside charging systems shown in FIGS. 1 to 2B.

FIG. 4 shows a schematic partial top view of a section of track.

FIGS. 5A to 5C show various examples of a battery electric multiple unit approaching a plurality of trackside charging systems.

FIG. 6A shows a schematic view of electrical connections in the onboard charging system and trackside charging system before charging has commenced.

FIG. 6B shows a schematic view of electrical connections in the onboard charging system and trackside charging system during charging.

FIG. 7 shows a flow diagram of a process for charging a battery electric vehicle in accordance with the present invention.

### DETAILED DESCRIPTION

Embodiments of the invention are described below in the context of battery electric multiple units. However, it will be readily appreciated that the invention is equally applicable to battery electric locomotives and other battery powered electric rail vehicles, including trams and light rail vehicles.

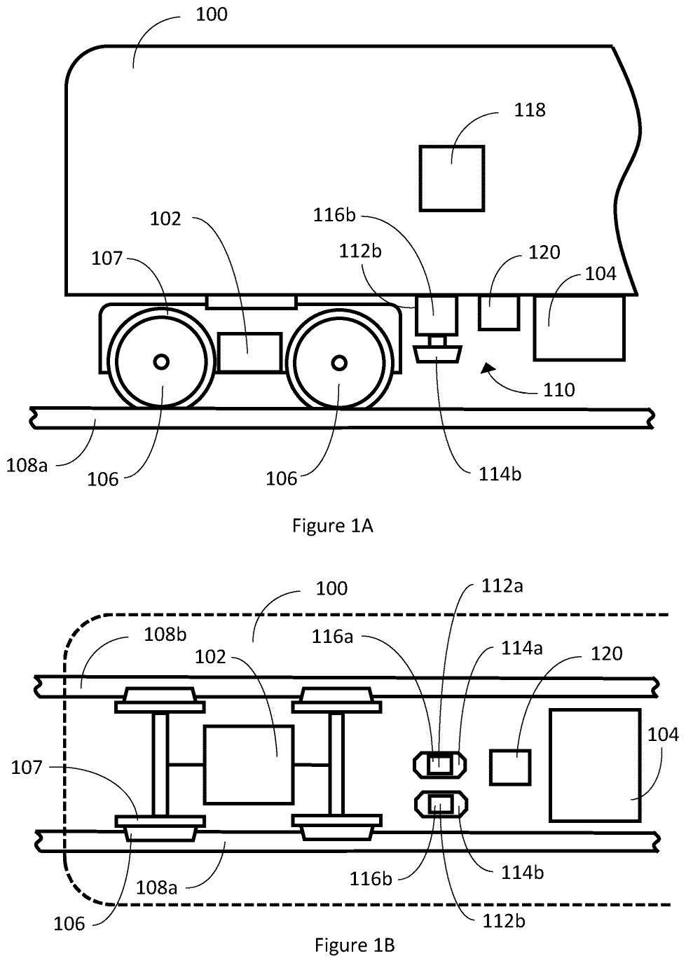

FIG. 1A shows a schematic side view of a portion of a battery electric rail vehicle 100. As shown, the battery electric rail vehicle 100 is a driving motor car in a battery electric multiple unit (BEMU), though it will be appreciated that the below applies equally to other types of battery electric rail vehicle. FIG. 1B shows a schematic top view of a portion of the same battery electric vehicle 100. In use, an electric motor 102 is configured to draw power from an on-board battery 104 and drive a plurality of driving wheels 106. The driving wheels 106 each have a flange 107 and run along first and second running rails 108a, 108b in the conventional manner.

The vehicle 100 also includes on-board (that is, vehicle-side) charging system 110. The on-board charging system 110 comprises at least one, and preferably at least two shoegear 112a, 112b positioned beneath the body of the driving motor car 100. Each shoegear 112a, 112b comprises a current collection contact, in this case a charging shoe 114a, 114b mounted to a respective actuator 116a, 116b. In the preferred embodiment, the charging shoes 114a, 114b are formed from a carbon-copper composite material, with a metallised carbon contact material, as is known in the art for use in conventional “third rail” electric rail vehicles (for example a carbon ceramic material with embedded copper threads such as MY258P grade Morganite® produced by Morgan Advanced Materials). We note that such materials are particularly advantageous over more traditional cast iron shoes used for some third rail electric vehicles in the present context-materials such as cast-iron risk being welded to the charging rail due to the high currents involved during charging and the fact the vehicle is stationary during charging in the present invention. In one example, the charging shoes 114a, 114b are rated to carry currents up to 1000A (or higher) at 850V (or higher). Preferably the actuators 116a, 116b are pneumatic actuators, although hydraulic or electromechanical (including electromagnetic) actuators can alternatively be used. The use of pneumatic actuators is particularly beneficial, in that it allows for flexibility in ride height due to wheel wear or vehicle load (which might change while charging is in progress) while maintaining a constant force on the charging shoe 114a, 114b. Pneumatic actuators allow for rapid deployment of the charging shoe 114a, 114b. As a further advantage, pneumatic actuators can also make use of pre-existing compressed air supplies on the electric rail vehicle 100.

It will be appreciated that multiple charging apparatuses 110 may be provided. Preferably, driving motor car 100 is part of a train consist, for example part of a multiple unit comprising a second driving motor unit (not shown) and optionally one or more non-driving carriages (not shown) between the driving motor car 100 and the second driving motor car. In such cases, one or more further charging apparatuses 110 can be provided on the second driving motor car and/or non-driving carriages. Alternatively, or in addition, driving motor car 100 may be provided with two or more charging apparatuses 110.

An onboard controller 118 is also provided to control, amongst other things, actuation of the actuators 116a, 116b. Each actuator 116a, 116b, under control of the onboard controller 118, is configured to move its associated charging shoe 114a, 114b between different positions, as explained in greater detail below. While the present embodiment as illustrated in FIGS. 1A and 1B employs a different actuator 116a, 116b for each charging shoe 114a, 114b, in alternative embodiments a single actuator may be used to simultaneously change the position of all of the charging shoes 114a, 114b provided in the on-board charging system 110. In some examples, the onboard controller 118 is or includes a traction control unit (TCU).

Preferably, the charging system 110 also includes a receiver 120 configured to receive wireless communication signals, for example a transceiver for interrogating RFID beacons.

The shoegear 112a, 112b can be positioned at various points on the underside of the driving motor car 100. A preferred position is proximate to, but forward of a trailing bogie of the driving motor car 100-this position helps ensure that the trackside charging contacts (discussed below) are fully covered by the driving motor car 100 itself during charging.

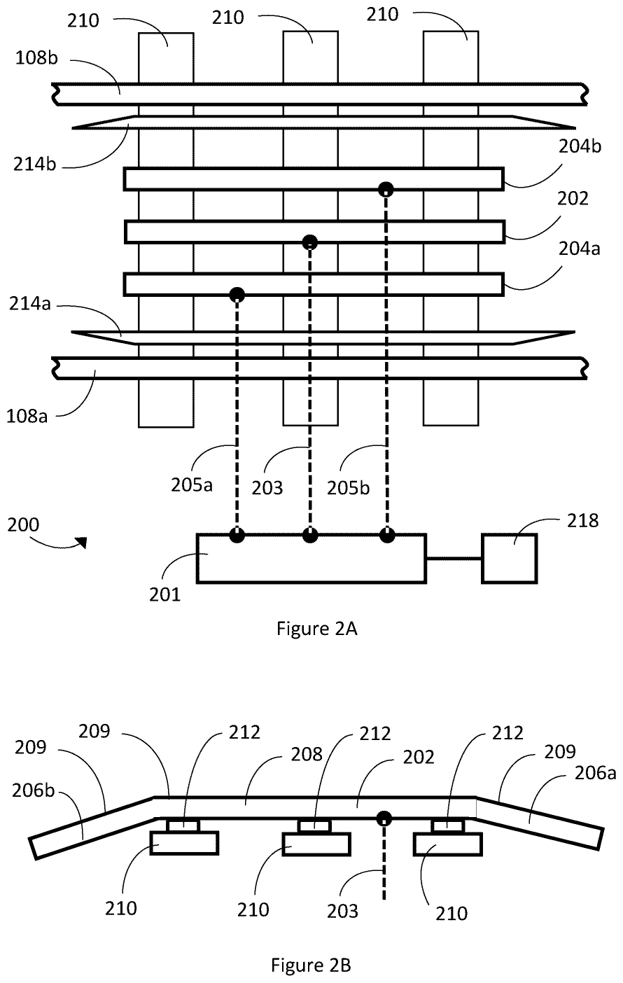

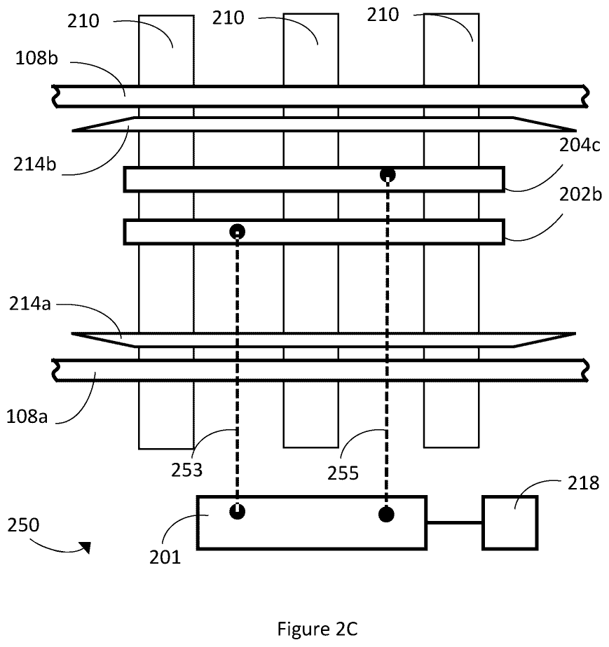

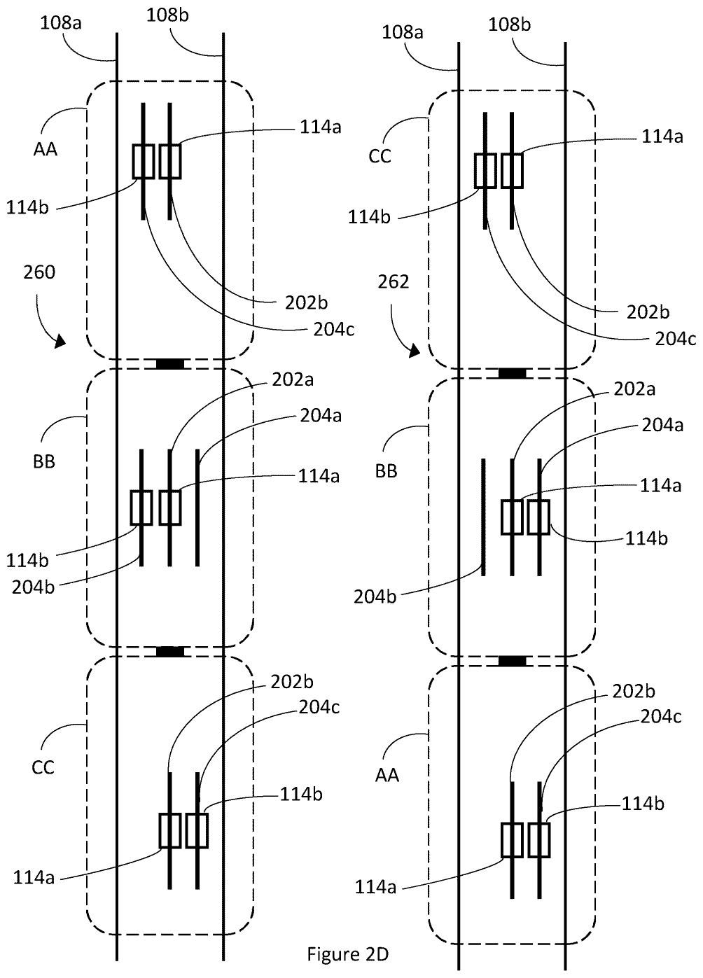

FIG. 2A shows a schematic top view of trackside charging infrastructure 200 configured to interact with the on-board charging system 110 described above. In this context, “trackside” refers to components that are not vehicle based, for example stationary components, for example positioned at, between or near to running rails 108a, 108b.

The trackside charging infrastructure 200 includes a power supply or connection to a power supply 201 and a trackside charging contact 202a-a schematic side view of the trackside charging contact 202a is shown in FIG. 2B. The trackside charging contact 202a is provided with a connection 203 that is selectively connectable to a first potential of the power supply 201 such that, when a suitable charging shoe 114a is in contact with the trackside charging contact 202a, a charging current can be selectively supplied to the battery 104 as discussed in more detail below.

The power supply 201 is preferably a trackside energy storage means, such as a battery. The power supply 201 is charged via a connection to an electrical power grid, or by local energy generation means (such as photovoltaic panels or wind turbines).

Preferably a trackside controller 218 is provided to control operation of the power supply 201 and the connections 203, 205a, 205b.

In the embodiment shown in FIGS. 2A and 2B, the charging contact 202a is a formed of an elongate steel rail (or more preferably an aluminium rail with a stainless steel surface for making contact with a respective current collection contact 114a, 114b), for example around 4 m long. Preferably, the trackside charging contact 202a comprises a first ramp portion 206a at a first distal end (and optionally a second ramp portion 206b at a second distal end), and a mid-portion 208 adjacent the first ramp portion 206a (and where provided, the second ramp portion 206b). The charging contact has a top surface 209 (preferably comprising stainless steel) that extends from the first ramp portion 206a to the mid portion 208 (and where provided, from the mid portion to the second ramp portion 206b). At the mid portion 208 the topmost surface 209 is substantially parallel to running rails 108a, 108b proximate the trackside charging contact 202a. From the mid portion 208, the topmost surface 209 then descends at the first ramp portion 206a (and where provided, the second ramp portion 206b). In the embodiment illustrated in FIGS. 2A and 2B, the trackside charging contact 202a is supported on sleepers 210 (also referred to as ties or crossties) by electrically insulating components 212. The trackside charging contact 202a may alternatively be supported by other structures (e.g., via electrically insulating components 212), for example when the running rails 108a, 108b are not supported by sleepers.

The trackside charging contact 202a is preferably dimensioned such that it can be completely covered by a train rake (for example by driving motor car 100 or other rail vehicles alone, or by being partially covered by two adjacent coupled vehicles, such that the trackside charging contact 202a is completely covered by the coupled vehicles in combination). Alternatively, the trackside charging contact 202a may have other configurations or materials.

In the illustrated embodiment, the trackside charging infrastructure 200 comprises a first further trackside charging contact 204a and a second further trackside charging contact 204b. Preferably the first and second further trackside charging contacts 204a, 204b are also formed from steel rails (or more preferably an aluminium rail with a stainless steel surface for making contact with a respective current collection contact 114a, 114b) in the same configuration as described above with respect to trackside charging contact 202a. Each of the first and second further trackside charging contacts 204a, 204b has a respective connection 205a, 205b that is selectively connectable to second potential of the power supply 201 different to the first potential, or to electrical ground. In one example, the trackside charging contact 202a is held at a positive potential during charging and the first and second further trackside charging contacts 204a, 204b are held at a negative potential during charging. During charging of battery 104, either the first or second further trackside charging contact 204a, 204b provides a return connection via the second charging shoe 114b.

Alternatively, it will be appreciated the trackside charging contact 202a may be selectively connected to the second potential or electrical ground and the first and second further trackside charging contacts selectively connected to the first potential.

In the preferred embodiment, the trackside charging contact 202a is positioned substantially equidistant between the first and second running rails 108a, 108b as shown in FIG. 2A. The first further trackside charging contact 204a is positioned between the first running rail 108a and the trackside charging contact 202a, and the second further trackside charging contact 204b is positioned between the second running rail 108b and the trackside charging contact 202a, such that the trackside charging contact 202a is also positioned substantially equidistant between the first and second further trackside charging contacts 204a, 204b.

Correspondingly, the first charging shoe 114a is positioned substantially centrally below the driving motor car 100, that is substantially equidistant between the first and second running rails 108a, 108b as shown in FIG. 1B. Additionally, the second charging shoe 114b is offset from the centre of the driving motor car by a distance corresponding to the distance between the trackside charging contact 202a and each of the first and second further trackside charging contacts 204a, 204b.

Advantageously, this arrangement allows for direction-agnostic charging-regardless as to the orientation of the driving motor car 100 as it approaches the trackside charging infrastructure 200, the first charging shoe 114a will always be connected to one potential via the trackside charging contact 202a, and the second charging shoe 114b connected to another potential via either the first or second further trackside charging contact 204a, 204b.

Optionally, one or more guide rails 214a, 214b are provided. Each guide rail 214a, 214b is positioned proximate to a corresponding running rail 108a, 108b, such that a flange on the wheels of the driving motor car 100 (for example a flange 107 of one of the driving wheels 106) follows a path between the respective guide rail 214a, 214b and the corresponding running rail 108a, 108b. This contains lateral movement of the driving motor car proximate to the trackside charging infrastructure 200, thereby improving alignment of the sharing shoes 114a, 114b relative to the trackside charging contact 202a and the further trackside charging contacts 204a, 204b. The guide rails 214a, 214b are preferably positioned such that wheels of the driving motor car 100 are constrained laterally when the charging shoe 114a is positioned over the trackside charging contact 202a. Though the guide rails 214a, 214b are shown proximate to the trackside charging contact 202a and the further trackside charging contacts 204a, 204b in FIG. 2A, it will be appreciated that they may be positioned or extend some distance in front of and/or behind the trackside charging contact 202a and the further trackside charging contacts 204a, 204b with respect to a direction of travel of rail vehicles.

Although the described arrangement with three trackside charging contacts 202a, 204a, 204b is preferred, alternatively two trackside charging contacts (e.g., one positive, one negative/ground), or more than three (e.g., more than one positive, more than one negative/ground).

A further embodiment is shown in FIG. 2C. In this arrangement, a trackside charging contact 202b and a single further trackside charging contact 204c is provided. In all other respects, this embodiment is identical to the embodiment of FIGS. 2A and 2B. The trackside charging contact 202b is positioned substantially centrally between the running rails 108a, 108b, and the further charging contact 204c is positioned between the trackside charging contact 202b and a running rail 108b. Preferably, one of the trackside charging contact 202b and the further trackside charging contact 204c is permanently connected to ground, with the other being selectively connectable to a voltage source.

As described below, more than one trackside charging system 200 can be provided at a certain location, to allow more than one battery-equipped vehicle in a train to be charged at the same time when the train is stopped. For example, several trackside charging systems 200 can be provided next to a platform corresponding to the positions of corresponding onboard charging systems 110 on one or more trains stopped at the platform. In these examples, each trackside charging system may have its own power source 201, or alternatively share a common power source 201.

The embodiment of FIG. 2C may be provided with the embodiment of FIGS. 2A to 2B. This is illustrated in FIG. 2D. FIG. 2D shows a train rake comprising a first driving motor car AA, and second driving motor car CC and a trailing car BB coupled between the first and second driving cars AA, CC. The train rake is shown in two different orientations 260, 262 relative to the first and second running rails 108a, 108b—orientation 260 shows driving motor car AA leading, and orientation 262 shoes the same train rake reversed, with driving motor car CC leading. Each of the first and second driving cars AA, CC and trailing car is provided with a pair of current collection contacts 114a, 114b as described in relation to FIGS. 1A and 1B above, and positioned as described above in relation for FIGS. 2A and 2B. In this arrangement, the trackside charging infrastructure is arranged so as to provide trackside charging contacts that allow charging to take place at each of the driving motor cars AA, CC and the trailing car BB.

As shown in FIG. 2D, trackside charging infrastructure according to the embodiment of FIG. 2C is provided at locations corresponding to the position of the two driving motor cars AA, CC when stopped. In this embodiment, regardless as to the orientation of the train rake, only a (central) trackside charging contact 202d and a single (offset) further trackside charging contact 204c needs to be provided for the driving motor cars AA, CC, as can be seen by comparing the orientations 206, 262 in FIG. 2D. However, at a position corresponding to the trailing car BB, preferably a (central) trackside charging contact 202a and two (offset) further trackside charging contacts 204a, 204b are provided as per the embodiment of FIGS. 2A and 2B. Changing the orientation of the train rake changes whether one of the current collection contacts 114b of the trailing car BB is positioned to the left or right of the centre of the trailing car BB with respect to its direction of travel. Thus, providing two further trackside charging contacts 204a, 204b ensures that the trailing car BB can participate in charging irrespective of the orientation of the train.

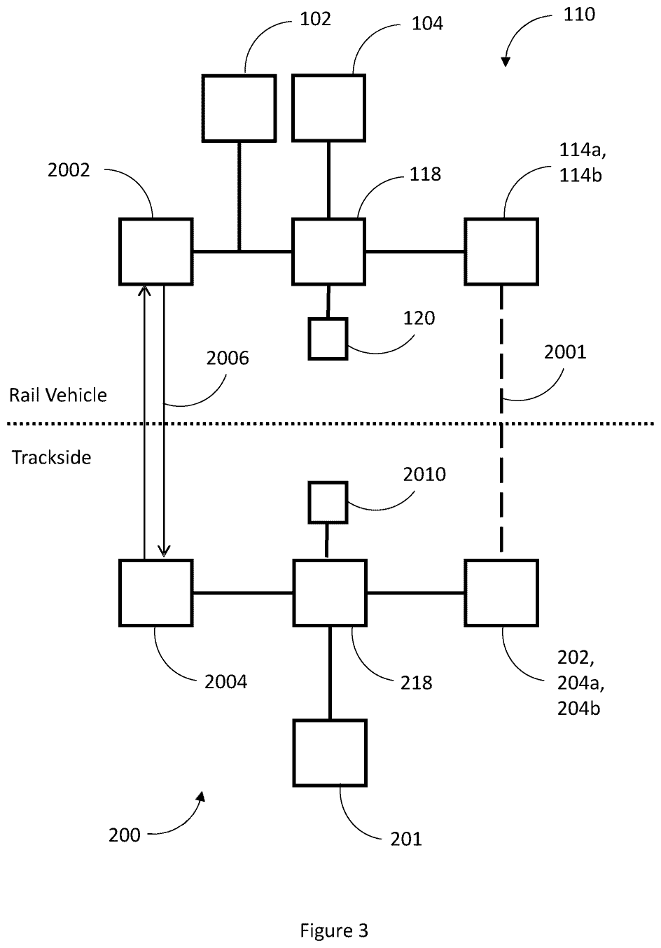

FIG. 3 shows a schematic overview of the interface between the onboard and trackside charging systems 110, 200. The onboard controller 118 comprises, or is communicatively coupled to, an onboard wireless communications interface 2002, for example configured to communicate via Wi-Fi®. The onboard controller 118 is configured to control the connection between the battery 104 and current collection contacts 114a, 114b (in the present embodiment, current collection shoes 114a, 114b), and optionally also the connection between the battery 104 and the motor 102. As described above, in the preferred embodiment, the onboard controller 118 is also configured to control deployment of the current collection shoes 114a, 114b. In the preferred embodiment, the onboard controller 118 is, or is part of, a traction control unit as mentioned above. Alternatively, the onboard controller 118 may be a battery management unit. Additional components (such as a battery management unit) may also be provided (not shown in FIG. 3). Preferably, the onboard controller 118 further comprises, or is communicatively coupled to a receiver 120 for example an RFID interrogator as discussed in more detail below.

It will be appreciated that a train may comprise more than one onboard charging system 110. Preferably a separate charging system 110 is provided for each vehicle in the train comprising a battery, for example for each driving motor car in a battery electric multiple unit. This allows independent charging of the one or more batteries 104 on a vehicle-by-vehicle basis. For example, if for any reason charging cannot proceed at one of the vehicles during a scheduled charging stop, the batteries of the remaining battery-equipped vehicles in the train can beneficially still be charged.

The trackside controller 218 comprises, or is communicatively coupled to, a trackside wireless communications interface 2004, for example configured to communicate via Wi-Fi®. The trackside controller 218 is configured to control the connection between the battery 104 and trackside charging contacts 202a, 204a, 204b. Preferably one or more proximity sensors 2010 are also provided, communicatively coupled to the trackside charging controller 218. The proximity sensor(s) 2010 are configured to detect the presence of a rail vehicle at the trackside charging system 200.

Prior to charging, an electrical connection 2001 is made between respective trackside charging contacts 202a, 204a, 204b and onboard current collection contacts 114a, 114b. As will be discussed in more detail below, the charging process is overseen by the onboard controller 118 via a secure wireless communication connection 2006 (for example a secure Wi-Fi® session) with the trackside controller 218 via the respective wireless communications interfaces 2002, 2004.

Preferably, each of the onboard controller 118 and trackside controller 218 has a respective means for communicating with an external computing system (not shown), for example via a cellular network. The onboard controller 118 is configured to periodically or continuously upload information indicative of the status and level of charge of the battery 104, operation of the shoegear 112a, 112b, currents and voltages measured during charging, etc. to the external computing system. Additionally other information regarding operation of the rail vehicle 100 is also preferably uploaded (for example by the onboard controller 118).

Similarly, the trackside controller 218 is configured to upload periodically or continuously information to the external computing system, for example regarding operation of the trackside charging system 200. Where the power supply 201 is a battery, the trackside controller 218 uploads information regarding the state of charge of the power supply 201 battery, and energy consumed from a grid connection or other source in charging the power supply 201 battery.

In this way, the invention allows for remote condition monitoring of both the rail vehicles and trackside charging systems. The information received can advantageously be used to identify, and preferably predict when repair or maintenance is needed, avoiding unnecessary maintenance and potential failures, and reducing the amount of time a rail vehicle 100 or trackside charging system 200 is not operational.

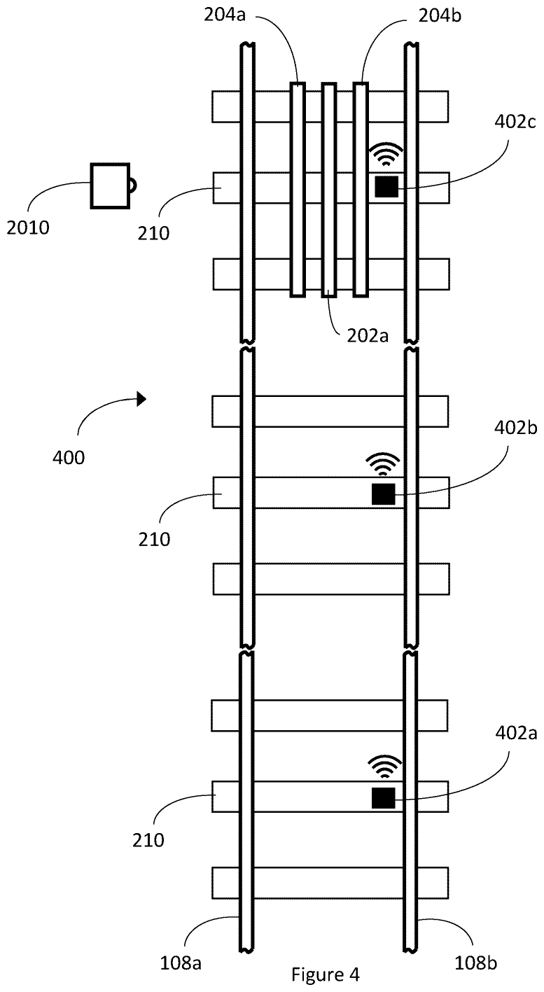

In the preferred embodiment, the onboard controller 118 is configured to operate the on-board charging system 110 based (at least in part) on signals received by the receiver 120. FIG. 4 shows a schematic partial top view of a section of track 400. On the approach to the trackside charging contact 202a and first and second further trackside charging contacts 204a, 204b, there is provided one or more transmitters 402a, 402b, 402c. Preferably the one or more transmitters 402a, 402b, 402c are RFID transponders or “beacons”. When the receiver 120 is within a certain range (for example around 600 mm) of a respective transmitter 402a, 402b, 402c, it interrogates the respective transmitter 402a, 402b, 402c. In response to the interrogation, the respective transmitter 402a, 402b, 402c transmits a predetermined signal in a manner known in the context of RFID transponders.

An optional first transmitter 402a is configured to transmit a signal indicative that the driving motor car 100 is on a route for which charging infrastructure 200 is provided. For example, the signal may indicate that the driving motor car 100 is following a route corresponding to a certain platform in a station, and that charging infrastructure 200 is available for that platform. As explained further below, the signal optionally indicates an expected rail vehicle direction of travel along the route or other information that indicates a relative position of two or more trackside charging systems, which can be used by the onboard controller to disambiguate which of a number of trackside controllers 218 should be communicated with.

RFID beacons often already exist proximate to the entrance to a length of track adjacent to a platform, and transmit a signal indicating which side of the train the platform will be, and therefore which side of the train doors should be opened once the train is stationary. Advantageously, known RFID beacons of this kind could be easily employed to also indicate whether charging infrastructure 200 is available and/or direction of travel.

In the preferred embodiment, a second transmitter 402b is configured to transmit a signal instructing that the one or more charging shoes 114a, 114b should be deployed. As the driving motor car 100 travels over the second transmitter 402b, the receiver 120 detects this signal, and in response the controller 118 causes the actuators 116a, 116b to move the charging shoes 114a, 114b, from their respective retracted positions to their deployed positions. Advantageously, this provides a simple and robust means for determining when to deploy the charging shoes 114a, 144b. The second transmitter 402b is positioned relative to the trackside charging contact 202a and first and second further trackside charging contacts 204a, 204b such that there is sufficient time for the actuators 116a, 116b to fully deploy before reaching the trackside charging contact 202a and first and second further trackside charging contacts 204a, 204b, accounting for an expected speed profile of the driving motor car 100. Preferably the second transmitter 402b is also positioned as close to the trackside charging contact 202a and first and second further trackside charging contacts 204a, 204b as possible, so as to reduce any risk that a deployed charging shoe 114a, 114b could interfere with other items or infrastructure located between the running rails 108a, 108b.

A third transmitter 402c is preferably provided proximate to the trackside charging contact 202a and first and second further trackside charging contacts 204a, 204b, and is configured to transmit a signal indicative that the driving motor car 100 is in a position suitable for charging to commence. Preferably the range of the third transmitter 402c is such that its signal is only transmitted when the first charging shoe 114a is in contact with the topmost surface 209 in the mid portion 208 of the trackside charging contact 202a, to further optimise electrical contact.

It will be appreciated that the transmitters 402a, 402b, 402c can be placed in a variety of positions relative to the running rails 108a, 108b. As shown in FIG. 4, the transmitters 402a, 402b, 402c are positioned on sleepers 210, between the running rails 108a, 108b, and offset from a midpoint between the running rails 108a, 108b. The transmitters 402a, 402b, 402c (and correspondingly receiver 120) can alternatively be placed at or closer to the midpoint between the running rails 108a, 108b, or even positioned outside of the running rails 108a, 108b (for example to the left of running rail 108a, or to the right of running rail 108b in the reference frame of FIG. 4).

As described above, preferably each battery-equipped vehicle in a train is preferably provided with its own charging system 110, allowing each battery 104 to be charged by a respective trackside charging system 100 when the train is stopped at a charging location (for example at a station equipped with trackside charging systems 200). In such circumstances, multiple onboard controllers 118 may have wireless communications interfaces 2002 in range of multiple trackside controller wireless communication interfaces 2004.

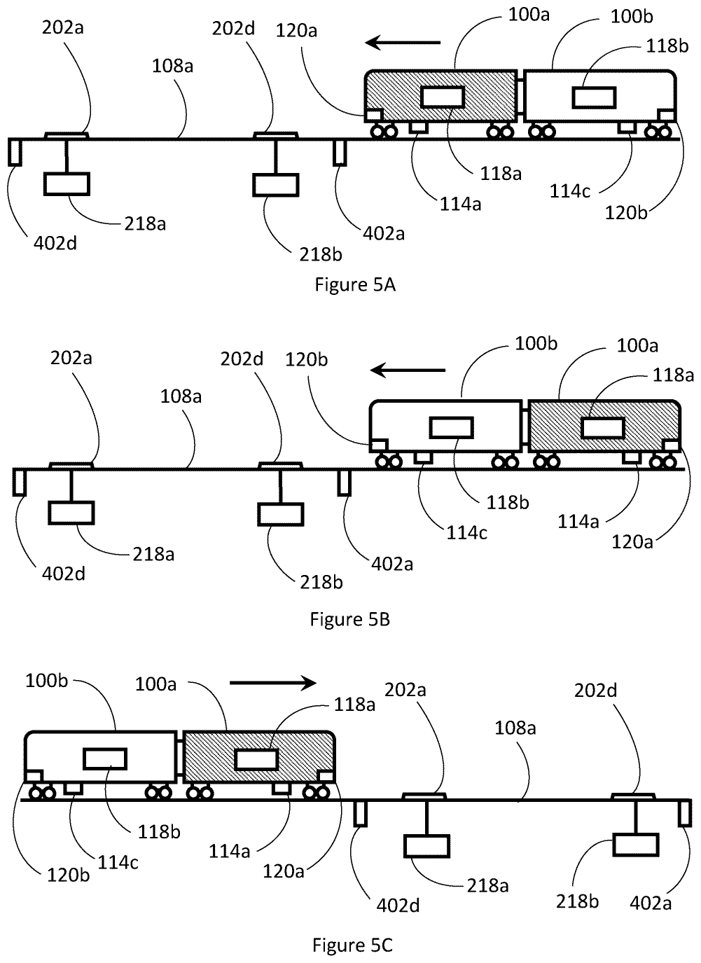

Advantageously, the present invention provides means for ensuring that each onboard controller 118 communicates with the correct trackside controller 218. This ensures, for example, the charging current demanded by a particular onboard controller 118 during charging is delivered to the correct battery 104. This is illustrated in FIGS. 5A to 5C.

A proximity sensor 2010 is also shown in FIG. 4 proximate to the trackside charging contacts 202a, 204a, 204b. The proximity sensor 2010 is configured to detect whether a rail vehicle is positioned over the trackside charging contacts 202a, 204a, 204b, and to communicate this information to the trackside charging controller 218.

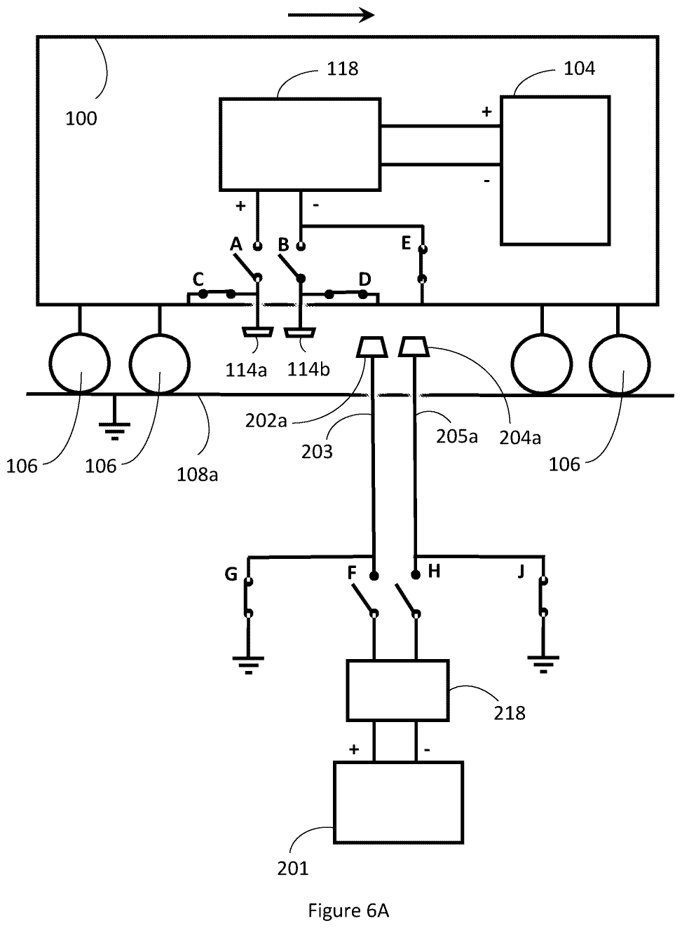

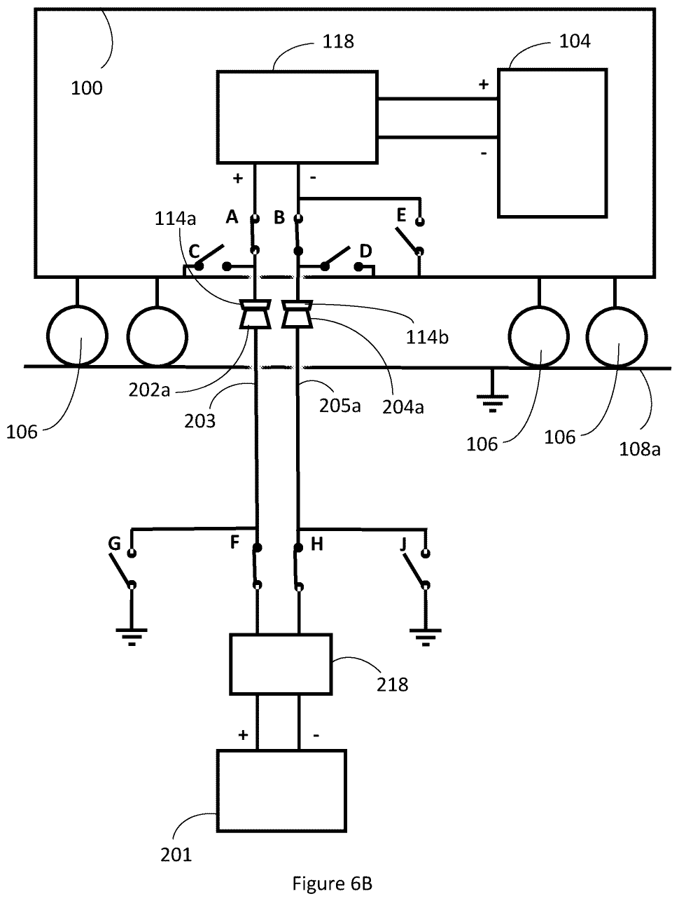

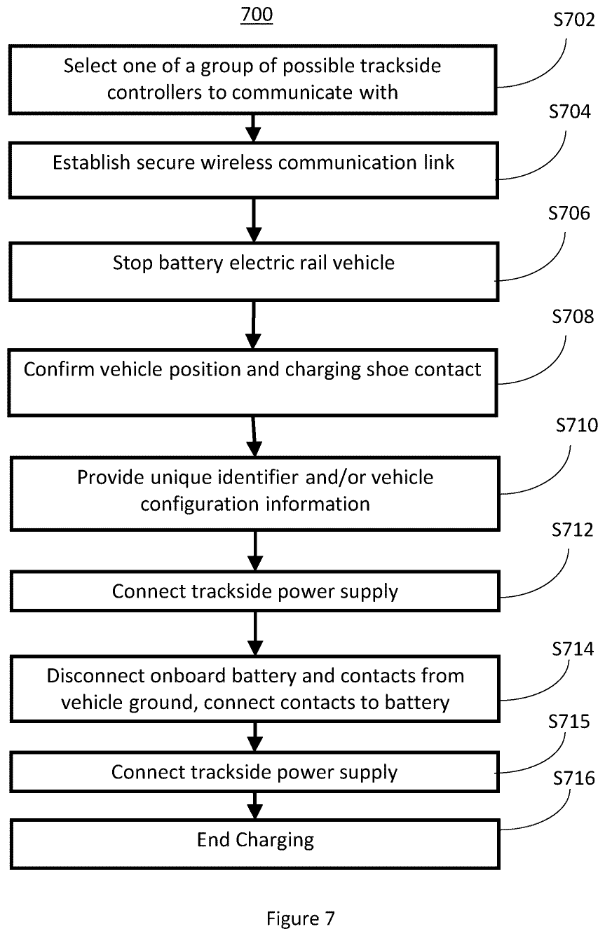

Operation of the onboard and trackside charging systems 110, 200 will now be described with reference to FIGS. 5A to 7. FIGS. 5A to 5C illustrate processes as a train approaches a charging location. FIGS. 6A to 6B illustrate electrical connections in the onboard and trackside charging systems 110, 200 prior to and during charging. FIG. 7 illustrates a method for operating the onboard and trackside charging systems 110, 200.

At step S702, the onboard controller 118 determines which trackside controller 218 it should communicate with. FIG. 5A shows a battery electric multiple unit comprising a first driving motor car 100a and a second driving motor car 100b, travelling from right to left. In this example, the first driving motor car 100a is leading, and the second driving motor car 100b is trailing. Each driving motor car 100a, 100b comprises a respective onboard controller 118a, 118b, a respective RFID interrogator (or other suitable signal receiver) 120a, 120b, and a respective current collection contact 114a, 114c (e.g., current collection shoes). Each onboard controller 118a, 118b is communicatively coupled to both RFID interrogators 120a, 120b.

Also shown are first and second trackside charging contacts 202aa, 202ab and corresponding trackside controllers 218a 218b, the trackside charging contacts 202aa, 202ab positioned apart such that charging current can be provided to the current collection contacts 114a, 114c of the first and second driving motor cars 100a, 100b simultaneously when the battery electric multiple unit stops at the correct position. Though two trackside charging contacts 202aa, 202ab are shown it will be appreciated that further charging contacts can be provided, to accommodate trains of longer length comprising more than two battery-equipped vehicles having onboard charging systems. Additionally, it will be appreciated that further trackside charging contacts 204a, 204b are provided with each trackside charging contact 202a as described in relation to FIGS. 2A and 4 above-these are omitted from FIGS. 5A to 5C for clarity of explanation.

The first and second trackside charging contacts 202aa, 202ab are positioned between a pair of RFID beacons (or other suitable signal transmitters) 402a, 402b. The RFID beacons 402a, 402b are each configured to provide information indicating an expected direction of travel, or other information that indicates the relative position of the trackside charging contacts 202aa, 202ab. As is known in the art, the direction a rail vehicle can travel along a route/portion of track is often restricted. For example, mainline routes often have an “up” line and a “down” line/an “inbound” line and a “outbound” line, or similar, along which rail vehicles travel in one direction only during normal operation. Accordingly, the expected direction of travel may be inferred from signals from the beacons 402a, 402b indicating they are on an “up” line or “down” line or similar.

Advantageously, by determining an expected direction of travel and determining which RFID interrogator 120a, 120b receives a signal from RFID beacon 402a first, each onboard controller 118a, 118b is able to determine which trackside controller 218a, 218b to communicate with.

As the battery electric multiple unit travels from right to left, the RFID interrogator 120a of the first driving motor car 100a interrogates, and receives a signal from, RFID beacon 402a, before the RFID interrogator 120b of the second driving motor car 100b. This information is provided to both the onboard controllers 118a, 118b. Knowing that the RFID interrogator 120a of the first driving motor car 100a encountered the first beacon 402a first, in combination with knowledge of the expected direction of travel received from the beacon 402a, the onboard controller 118a of the first driving motor car 100a determines that should communicate with trackside controller 218a. Similarly, and based on the same information, the onboard controller 118b of the second driving motor car 100b determines that it should communicate with trackside controller 218b.

A second example is shown in FIG. 5B. in this case the battery electric multiple unit is again travelled from right to left, but the position of the first and second driving motor cars 100a, 100b is reversed (i.e., the second driving motor car 100b is leading and the first driving motor car 100a is trailing). In this case the RFID interrogator 120b of the second driving motor car 100b interrogates RFID beacon 402a before the RFID interrogator 120a of the first driving motor car 100a. Based on this information and the expected direction of travel indicted in the signal from the beacon 402a, the onboard controller 118a of the first driving motor car 100a determines that should communicate with trackside controller 218b, and the onboard controller 118b of the second driving motor car 100b determines that it should communicate with trackside controller 218a.

A third example is shown in FIG. 5C. In this example, the battery electric multiple unit is travelling from left to right, with the first driving motor car 100a leading. In this case, the RFID interrogators 120a, 120b interact with the second beacon 402d, which again provides a signal indicating an expected direction of travel. Based on this signal, and on the first RFID interrogator 120a receiving the signal before the second RFID interrogator 120b, the first onboard controller 118a determines to communicate with the second trackside controller 218b, and the second onboard controller 118b determines to communicate with the first trackside controller 218a.

Once an onboard controller 118 has determined which trackside controller 218 it should communicate with, the onboard controller 118 establishes the secure wireless connection 2006 with the appropriate trackside controller 218 in step S702, for example using a wireless handshake procedure known in the art. The secure wireless connection 2006 may be established once the rail vehicle 100 has been brought to a stop in step S706, with current collection contacts 114a, 114b in electrical contact with corresponding trackside charging contacts 202a, 204a, 204b. Alternatively, as shown in FIG. 7, the secure wireless connection 2006 is established while the rail vehicle 100 is still in motion (i.e. before it stopes in step S706), thus reducing the time taken to initiate charging once the current collection contacts 114a, 114b in electrical contact with corresponding trackside charging contacts 202a, 204a, 204b.

The onboard controller 118 is configured to control electrical connections to the battery 104 and current collection contacts 114a, 114b. FIG. 6A shows connections prior to the current collection contacts 114a, 114b being brought into electrical contact with corresponding trackside charging contacts 202a, 204a.

It is to be understood that the third charging contact 204b is preferably also provided at positions corresponding to trailing cars BB having current collection contacts (as described in relation to FIG. 2D), but this is omitted from FIGS. 6A and 6B for clarity of explanation. In this case, both the two further trackside charging contacts 204a, 204b are preferably connected together, such that they are held at the same electrical potential during charging (for example electrical ground).

Alternatively, the onboard controller 118 optionally transmits train configuration/orientation information (for example based on determining which RFID interrogator 120a, 120b was first to interact with a respective beacon 402a, 402d as discussed above). For example, this information indicates which of the two further trackside charging contacts 204a, 204b will be in contact with the current collection contact 114b of that trailing car BB, such that said further trackside charging contact 204a, 204b is optionally selectively connected to a power supply 201, while the other remains isolated/connected to ground.

The onboard controller 118 keeps the current collections contacts 114a, 114b disconnected from the battery 104 (for instance using contactors A and B) and connected to a rail vehicle chassis (for instance using contactors C and D). The rail vehicle chassis, through bogies and wheels 106, provide a connection to electrical ground via the running rails 108a, 108b. A negative or ground terminal of the battery 104 is also connected to the vehicle chassis (i.e., the same electrical ground), for example via contactor E.

In the absence of a secure wireless connection 2006, the trackside controller 218 keeps at least a positive terminal of the power supply 201 disconnected from the corresponding trackside charging contact 202a, for example by contactor F, and keeps said trackside charging contact 202a connected to ground, for example by contactor G. As shown in FIG. 6A, a negative terminal of the power supply is connectable to negative trackside charging contact 204a via contactor H, and, optionally negative trackside charging contact 204a is connectable to ground via contactor J-in an alternative arrangement the negative trackside charging contact 204a (and optionally the negative terminal of the power supply 201) is permanently connected to electrical ground. In some examples, elements F and H are contacts on a common contactor.

Though contactors are preferred, it will be appreciated that contactors A, B, C, D, E, F G, H, J may each be replaced by other types of electrical switching device including, for example, circuit breakers.

At step S708, the onboard controller 118 confirms that the current collection contacts 114a, 114b have been brought into electrical contact with corresponding trackside charging contacts 202a, 204a, 204b. In one example, the onboard controller 118 receives a signal from one or more pressure sensor connected to the actuators 116a, 116b indicating that a force is applied between the current collection contacts 114a, 114b and respective trackside charging contacts 202a, 204a, 204b. Preferably, the onboard controller also confirms that the onboard receiver (e.g., RFID interrogator) 120 is receiving a signal from the third transmitter (e.g., RFID beacon) 402c.

Additionally, the trackside controller is configured to monitor, based on a signal from each of the one or more proximity sensors 2010, whether a rail vehicle is positioned over the trackside charging contacts 202a, 204a, 204b. If no rail vehicle is detected, then the trackside controller 218 prevents trackside charging contacts 202a, 204a, 204b being connected to the power supply 201. The proximity sensors thus form a hardwired interlock to prevent the trackside charging contacts becoming energised when no rail vehicle is present.

At step S710, the onboard controller 118 is configured to provide, via the secure wireless connection 2006, vehicle configuration information (for example, which way round the train is, as indicated by which RFID interrogator 120a, 120b read the beacon 402a first) and a unique identifier (for example a unique IP address assigned to that onboard controller 118). Using the vehicle configuration information provided by the onboard controller 118 and the unique identifier, the trackside controller 218 then determines the positions of the current collection contacts 114a, 114b relative to the trackside charging contacts 202a, 204a, 204b, to determine which of the trackside charging contacts 202a, 204a, 204b are in contact with the current collection contacts. Depending on the arrangement of trackside charging contacts 202a, 204a, 204b, the trackside controller 218 may advantageously forgo energising any positive trackside charging contact 202a, 204a, 204b that is not in contact with a charging contact current collection contact 114a, 114b during charging. For example, track at a particular station platform may have multiple sets of trackside charging contacts 202a, 204a, 204b (for example three or more) at different positions along the track, for charging trains with a corresponding number of sets of current collection contacts 114a, 114b (e.g. three or more). However, some trains may only have fewer sets of current collection contacts 114a, 114b (e.g. two, one at each driving motor car)-in such circumstances the present invention can advantageously ensure that any sets of trackside charging contacts 202a, 204a, 204b not in contact with current collection contacts 114a, 114b are not energised. The unique identifier is used when tracking how much energy has been provided to a particular rail vehicle or battery, for example for condition monitoring, maintenance, and/or invoicing purposes.

Additionally, the trackside controller 218 optionally determines, based on the unique identifier, whether the onboard controller 118 is authorised to instruct charging at the trackside charging system 200. For example, only rail vehicles having the correct/compatible equipment may be permitted to charge at the trackside charging system 200. In this case, the trackside controller 218 has access to a data repository indicating the unique identifiers of all authorised onboard controllers 118 and is configured to prevent charging taking place if the received unique identifier does not match the unique identifier of any authorised onboard controller 118.

The onboard controller 118 then sends an instruction to the trackside controller 218 over the secure wireless connection 2006 to connect the power supply 201 at step S712. The trackside controller 218 then connects the appropriate trackside charging contacts 202a, 204a to the power supply 201 (for example using contactors G, F and H, and optionally J if the negative charging contact 204a is not permanently connected to electrical ground). This is shown in FIG. 6B.

Preferably, the onboard controller 118 then draws a first, relatively low, current from the power supply 201 through the trackside charging contacts 202a, 204a, 204b and current collection contacts 114a, 114b, to a resistor or other suitable electrical load (not shown) onboard the rail vehicle 100. In an example, the resistor has a resistance of around 5002. While this first current is provided, the onboard controller 118 is configured to measure a voltage at the current collection contacts 114a, 114b. Similarly, the trackside controller 218 is configured to measure a voltage at the trackside charging contacts and send the measured value to the onboard controller 118 via the secure wireless connection 2006. The onboard controller 118 then compares the difference between the voltage measured at the current collection contacts 114a, 114b and the voltage measured at the trackside charging contacts to a predetermined threshold value. If the difference is below the threshold value, then the onboard controller 118 determines that the electrical connection between the current collection contacts 114a, 114b and the trackside charging contacts 202a, 204a, 204b is of acceptable quality (i.e., the resistance between the current collection contacts 114a, 114b and the trackside charging contacts 202a, 204a, 204b is low enough for charging to continue).

At step S714, the onboard controller 118 then disconnects the current collection contacts 114a, 114b and the negative/ground terminal of the battery 104 from the vehicle chassis (e.g., using contactors C, D and E. The onboard controller 118 further connects the current collection contacts 114a, 114b to respective terminals of the battery 104 (e.g., using contactors A and B). Advantageously, by removing the earth connection between the battery 104 and the chassis during charging, the risk that current flows via the vehicle 100, wheels 106 and running rails 108a, 108b is reduced/obviated, thereby enhancing safety for persons proximate to the rail vehicle 100 during charging.

The onboard controller 118 then ramps up the charging current from the power supply 201 to a second, higher current, which is provided to the battery 104 (preferably bypassing the resistor), thereby charging the battery 104. Beneficially, by testing the resistance between the contacts 114a, 114b, 202a, 204a, 204b at low currents in this way, in the event that the resistance is too high, damage or other undesirable effects caused by attempting to apply the full second charging current can be avoided. In some examples, the first current is around 15 A and 750V, and the second charging current is around 1000 A at 850 V, allowing for very rapid charging of the battery 104. The battery 104 is then charged using the second current across connection 2001 at step S715.

During charging at step S715, the onboard controller 118 is preferably configured to continue monitoring a difference between the voltage measured at the current collection contacts 114a, 114b and a voltage at respective trackside charging contacts 202a, 204a, 204b as communicated by the trackside controller 218. Put differently, the onboard controller 118 continues to monitor the quality of the electrical connection 2001 between the current collection contacts 114a, 114b and the trackside charging contacts 202a, 204a, 204b.

Preferably the onboard controller 118 is further configured to receive a signal from a differential current sensor indicative of a difference between a supply current and a return current. The onboard controller 118 monitors this signal to determine if the difference is not within a predefined range (for example the difference is non-zero), and thus identify if there is current leakage to earth.

At step S716, the onboard controller 118 ends charging, preferably responsive to one or more of the following conditions being satisfied:
The battery reaching a predetermined state of charge. The onboard controller 118 determines that the level of charge of the battery 104 (either directly or via an intermediate battery management unit) is approaching, matches or exceeds a desired level of charging (for example 80%, 90% or 100% charged). The desired level of charge is predetermined, for example based on the level of charge needed to power the rail vehicle 100 at least until it recaches the next charging system 200 along the route it is following.
The rail vehicle 100 prepares to move. The onboard controller 118 determines, for example via a signal received from a power-brake selector (not shown) that a driver of the vehicle 100 has applied tractive power or released vehicle brakes.
An interlock changes state (for example proximity sensor 2010 no longer detects the presence of a vehicle, or the receiver 120 stops receiving the signal from the third RFID beacon 402c).
A fault is detected (for example one of the contactors A, B, C, D, E, F, G, H of J is not in the correct position).
A poor electrical contact between the current collection contacts 114a, 114b and the trackside charging contacts 202a, 204a, 204b is detected (e.g., the onboard controller 118 determines that the difference between the measured voltages exceeds the predetermined threshold).
A leakage current is detected (for example if the onboard controller 118 determines, based on the signal from the differential current sensor, that there is current leakage to earth.
An emergency stop button is actuated.

As noted above, the trackside controller 118 will also independently end charging if the secure wireless connection 2206 is lost.

Once the onboard controller 118 has determined to end charging, it rapidly ramps down the current from the power supply 201 to the trackside charging contacts 202a, 204a, 204b to zero, and instructs (via the secure wireless connection 2206) the trackside controller 218 to disconnect the power supply 201 from the trackside charging contacts 202a, 204a, 204b (e.g., using contactors F and H) and reconnect the trackside charging contacts 202a, 204a, 204b to ground, e.g., using contactors G and J (though, as described above, in some examples the negative trackside charging contacts 204a, 204b are permanently connected to electrical ground). Similarly, the onboard controller 118 disconnects the battery 104 from the current collection contacts 114a, 114b (for example using contactors A and B) and reconnects it to the traction motor 102. The onboard controller 118 also reconnects the current collection contacts 114a, 114b and the negative terminal of the battery 104 to the vehicle chassis (e.g., using contactors C, D and E) in order to provide a route to ground. The rail vehicle 100 is then able to move away, and the secure wireless communication session 2006 is ended.

In the event that an emergency stop button is pressed, or the proximity sensors 2010 detect that the rail vehicle 100 has moved, the various contactors A, B, C, D, E, F, G, H, J are controlled by the onboard and trackside controllers 118, 218 respectively so as to disconnect the power supply, trackside charging contacts 202a, 204a, 204b, current collection shoes 114a, 114b and battery 104 immediately, prior to ramping down the current in the interest of further enhancing safety.

The present invention also provides one or more computer-readable medium (for example a non-transitory computer readable medium) comprising instructions that, when executed on one or more processors (for example processors of the onboard and trackside controllers 118, 218), cause the processors to perform the method 700 described above in part or in its entirety.

The above embodiments are provided as examples of the present invention only and are not limiting. The present invention is defined by the appended independent claims, and encompasses all variants and equivalents falling within the scope of those claims. Further aspects of the invention will be understood from the appended claims.

1. An onboard charging system configured for installation on a rail vehicle, the onboard charging system comprising:
one or more current collection contacts;
a battery, electrically connectable to the one or more current collection contacts; and
an onboard charging controller having, or being communicatively coupled to, a wireless communications interface, wherein the onboard charging controller is configured to:
establish a secure wireless communication session with a first trackside charging controller; and
responsive to determining that the one or more current collection contacts have been brought into electrical contact with corresponding trackside charging contacts:
instruct the first trackside charging controller, via the secure wireless communication session, to connect an electrical power supply to the trackside charging contacts; and
draw a first current from the electrical power supply via the one or more trackside charging contacts, thereby charging the battery,
the charging system further comprising a first signal receiver and a second signal receiver;
wherein, prior to establishing the secure wireless communication session, the onboard controller is configured to select the first trackside controller to communicate with from a plurality of trackside controllers based on receiving a first signal from a trackside signal transmitter at the first signal receiver prior to receiving a second signal from the trackside signal transmitter at the second signal receiver and thereby determining the orientation of the rail vehicle relative to the trackside charging contacts.

2. The onboard charging system of claim 1, wherein:
the onboard controller is configured to determine that the one or more current collection contacts have been brought into electrical contact with the trackside charging contacts based on the first signal receiver receiving a third signal from a second trackside signal transmitter;
the onboard controller is configured to instruct the first trackside controller to stop providing current if the first signal receiver stops receiving the third signal.

3. The onboard charging system of claim 1, wherein, responsive to the first current being provided, the onboard controller is configured to:
monitor a first voltage at the one or more current collection contacts;
receive information from the first trackside controller, via the secure communication session, indicative of a second voltage at the one or more trackside charging contacts;
compare a difference between the first voltage and the second voltage to a threshold value; and
in response to determining that the difference is below the threshold value:
connect the one or more current collection contacts to the battery; and
draw a second current, higher than the first current, from the electrical power supply.

4. The onboard charging system of claim 1, wherein the onboard controller is configured to determine that one or more current collection contacts have been brought into electrical contact with the corresponding trackside charging contacts based on receiving a signal from a proximity sensor indicative of the rail vehicle being proximate to the trackside charging contacts.

5. The onboard charging system of claim 1 further comprising an earthing connection connected to a rail vehicle chassis, wherein the onboard controller is configured to:
responsive to determining that the one or more current collection contacts have been brought into electrical contact with the corresponding trackside charging contacts, and prior to connecting the battery to the one or more current collection contacts, disconnect the battery and the one or more current collection contacts from the earthing connection.

6. The onboard charging system of claim 1, wherein the onboard controller is configured to collect data including a level of charge of the battery, and transmit the data to an external computing device for remote condition monitoring.

7. A rail vehicle comprising the onboard charging system of claim 1.

8. A trackside charging system configured for charging a battery electric vehicle, the trackside charging system comprising:
a first trackside charging contact electrically connectable to an electrical power supply; and
a trackside controller having, or being communicatively coupled to, a wireless communications interface, wherein the trackside charging controller is configured to:
establish a secure wireless communication session with a first onboard charging controller;
receive, via the wireless communication session, an instruction;
responsive to receiving the instruction, connect the first trackside charging contact to the electrical power source,
wherein the trackside charging system comprises a plurality of trackside charging contacts electrically connectable to the electrical power supply;
the trackside controller being configured to select the first trackside contact for connection to the electrical power supply based on a unique identifier received from the first onboard controller via the secure wireless communication session.

9. The trackside charging system of claim 8, wherein the trackside controller is configured to disconnect the first trackside charging contact from the electrical power supply responsive to the secure wireless communication session being lost.

10. The trackside charging system of claim 8-or claim 9 further comprising an earthing line connected to electrical ground, wherein the controller is configured to:
responsive to receiving the instruction and prior to connecting the first charging contact to the electrical power supply, disconnect the first charging contact from the earthing line.

11. The trackside charging system of claim 8 further comprising a proximity sensor configured to detect the presence of a rail vehicle at a position corresponding to the first charging contact, wherein the trackside controller is configured to:
connect the first charging contact to the electrical power source responsive to receiving the instruction and receiving a signal from the proximity sensor indicative of a rail vehicle being present at a position corresponding to the first charging contact; and
disconnect first charging contact from the electrical power source responsive to no longer receiving the signal from the proximity sensor.

12. The trackside charging system of claim 8, wherein the trackside controller is further configured to:
monitor a first voltage at the first trackside contact while the first current is being provided;
communicate the monitored first voltage to the onboard controller via the secure wireless communication session.

13. The trackside charging system of claim 8, wherein the trackside controller is configured to collect data including a level of charge of the power supply, and transmit the data to an external computing device for remote condition monitoring.

14. A rail vehicle charging system comprising:
the onboard charging system of claim 1; and
the trackside charging system of claim 8.

15. A method of charging a battery on a rail vehicle, the method comprising:
establishing a secure wireless communication session between an onboard controller located on the rail vehicle and a first trackside charging controller; and
determining that a first current collection contact located on the rail vehicle has been brought into electrical contact with a first corresponding trackside charging contact;
in response to the determining:
transmitting, by the first trackside charging controller to the onboard controller via the secure wireless communication session, an instruction; and
in response to the receiving the instruction at the first trackside controller:
connecting, by the first trackside controller, the first trackside charging contact to an electrical power supply;
drawing, by the onboard controller a first current from the electrical power supply,
the method further comprising, prior to establishing the secure wireless communication session:
selecting, by the onboard controller, the first trackside controller to communicate with from a plurality of trackside controllers based on receiving a first signal from a trackside signal transmitter at a first signal receiver prior to receiving a second signal from the trackside signal transmitter at a second signal receiver.

16. The method of claim 15:
wherein determining that the first current collection contact has been brought into electrical contact with the first trackside charging contact comprises receiving a third signal from a second trackside signal transmitter;
the method further comprising, by the onboard controller, ceasing to draw the first current if the first signal receiver stops receiving the third signal.

17. The method of claim 15, further comprising:
monitoring a first voltage at the one or more current collection contacts;
monitoring a second voltage at the one or more trackside charging contacts;
comparing a difference between the first voltage and the second voltage to a threshold value; and
in response to determining that the difference is below the threshold value:
connecting the battery to the one or more current collection contacts;
drawing, by the onboard controller, a second current, higher than the first current.

18. The method of claim 15, wherein determining that the first current collection contact has been brought into electrical contact with the first trackside charging contact comprises receiving a signal from a proximity sensor indicative of the rail vehicle being proximate to the trackside charging contacts.

19. The method of claim 15 further comprising:
responsive to determining that the first current collection contact has been brought into electrical contact with the first trackside charging contact, and prior to connecting the battery to the first current collection contact, disconnecting the battery and the first current collection contact from the earthing connection.

20. The method of claim 15 further comprising:
receiving, by the first trackside controller and via the secure wireless communication session, a unique identifier from the onboard controller
selecting, by the first trackside controller the first trackside charging contact from a plurality of trackside charging contacts for connection to the electrical power supply based on the unique identifier.

21. The method of claim 15 further comprising disconnecting the first charging contact from the electrical power supply responsive to the secure wireless communication session being lost.

22. The method of claim 15 further comprising:
responsive to receiving the instruction and prior to connecting the first charging contact to the electrical power supply, disconnecting the first charging contact from an earthing line.

23. The method of claim 15, further comprising sending data to an external computing device for remote monitoring, the data comprising one or more of:
a state of charge of the battery;
a state of charge of the electrical power supply.

24. A computer-readable medium comprising instructions that, when executed on one or more processors cause the one or more processors to perform the method of claim 15.
